(19) United States
(12) Patent Application Publication
(10) Pub. No.: US 2010/0063822 A1
(43) Pub. Date: Mar. 11, 2010

(54) COMMUNICATION SYSTEM FOR SPEECH DISABLED INDIVIDUALS

(76) Inventors: Daniel C. O'Brien, Gainesville, VA (US); Edward T. Buchholz, Moneta, VA (US)

Correspondence Address: JONES, TULLAR & COOPER, P.C., P.O. BOX 2266 EADS STATION, ARLINGTON, VA, 22202, US

(21) Appl. No.: 12/596,459

(22) PCT Filed: Apr. 21, 2008
(86) PCT No.: PCT/US08/61069

§ 371 Date: Oct. 19, 2009

Related U.S. Application Data
(60) Provisional application No. 60/907,857, filed on Apr. 19, 2007.

(51) Int. Cl. G10L 21/06

(52) U.S. Cl. 704/271; 704/E21.019

(57) ABSTRACT

A communication system that is specifically designed for the needs of speech impaired individuals, particularly aphasia victims, makes use of a speech generating mobile terminal communication device (SGMTD) (12) that is designed to be hand held and operated by a speech disabled individual. The SGMTD includes a database of audio files that are accessed to generate full sentences in response to single word or short phrase entries selected from a plurality of menus by the disabled user. A second, companion mobile terminal device (COMTD) (14) enables a caregiver to communicate with the speech disabled individual's SGMTD to assist the individual in communicating with the caregiver by causing the SGMTD to switch to a particular menu or list from which the caregiver wants the disabled individual to make a selection. The SGMTD also includes software that enables the device to communicate with other SGMTDs via wireless communications and thereby simulate a verbal conversation between speech impaired individuals.

### BACKGROUND OF THE INVENTION

1. Field of the Invention

The present invention relates in general to a speech generating system for facilitating communications by and with individuals who are unable to speak. The system employs two different types of hand held terminal devices, one which enables speech disabled individuals to communicate with caregivers and also with other speech disabled individuals. The second device enables a caregiver to communicate with the disabled individual's device and assist the individual in using the same.

2. Description of the Background Art

Victims of strokes, traumatic brain injuries and head injuries often develop a condition known as aphasia. Aphasia is a loss of the ability to produce and/or comprehend language due to injury to brain areas specialized for these functions. This condition is not a result of deficits in sensory, intellect, or psychiatric functioning, nor due to muscle weakness or a cognitive disorder. Depending on the area and extent of the damage, someone suffering from aphasia may be able to speak but not write, or vice versa, or display any of a wide variety of other deficiencies in language comprehension and production, such as being able to sing but not speak.

Individuals with aphasia are often able to understand the speech of others to varying degrees. Because of this, they are often aware of their difficulties and can become easily frustrated by their speaking problems. This is particularly so in cases where the affected individual cannot speak at all and can only read single words or small phrases at best, even though they may fully comprehend what is begin spoken to them by caregivers or other non-disabled individuals. These cases cause even more frustration for the individual with aphasia.

Numerous devices are on the market to help individuals with aphasia to regain their speech, but there are few known devices which can be used to help them communicate. Typically, such devices are crude at best and provide only a rudimentary means of communication in which only a few simple commands may be initiated, for example. As a result, there is a present and growing need for a communication assistance device that is designed specifically for assisting speech impaired individuals in communicating in a substantial manner with other individuals, who may themselves be disabled.

### SUMMARY OF THE INVENTION

The present invention fulfills the foregoing need by providing a communication system that is specifically designed with the needs of speech impaired individuals, particularly aphasia victims, and their caregivers in mind. The system represents the first known system that allows aphasia victims to communicate effectively and with a broad vocabulary either with non-disabled caregivers, or with a similarly disabled aphasia victim, for example.

To accomplish the foregoing, the communication system makes use first of a speech generating mobile terminal communication device (SGMTD) that is designed to be hand held by a speech disabled individual (referred to hereinafter for simplicity as the “survivor” because most such individuals will be stroke survivors) and operated preferably with a thumb or finger since a stroke victim usually loses either left or right side mobility including the use of their arm and hand. A second, companion mobile terminal device (COMTD) enables a caregiver to communicate with their survivor's SGMTD to assist the survivor in communicating with the caregiver as will be discussed in further detail herein

The SGMTD preferably includes a touch screen display that allows the user to view and enter selections from a displayed menu screen. Located inside the SGMTD housing are a number of electronic elements that facilitate speech generation through playing of pre-stored audio files, wireless communication with other devices, programming of the SGMTD with individualized menus, etc. More specifically, the SGMTD preferably includes at least first and second wireless transceivers, such as a BLUE TOOTH based or similar RF transceiver and an infrared line-of-sight transceiver, which facilitate communications with the caregiver COMTD and with other SGMTDs, respectively. A microprocessor is provided which is programmed with an audio codec (e.g. MP3) that accesses stored streaming audio clips in memory, then decodes and sends them to an audio subsystem. The audio subsystem includes a D/A converter amplifier and audio speaker which play spoken sentences or phrases in response to selections made by the survivor. The microprocessor also includes an Internet direct to company web site application to facilitate web based programming, and software for interactivity between two separate devices and an Internet site that will interact with the SGMTD for speech interaction while on the Internet using the Internet speech solutions or the solutions currently installed on the device.

Because aphasia patients are usually capable of reading, but function best when only having to deal with a limited number of words, the SGMTD is preferably programmed with long lists of single words or short phrases that the survivor can select from using menu trees. The menus and subsets are thus held to a single word as much as possible since an aphasia patient has a problem stringing multiple words together. A two tier menu tree is preferably used in which the first tier is displayed on the SGMTD main screen which initially shows a category to select from such as: beverages, stores, restaurants, feelings, toiletries, etc. Selection of a category causes the screen to display a second tier menu which is a list of items in the selected category.

In the preferred embodiment, the menu lists comprise three distinct types: definitive, choice and interactive. Definitive or single response lists contain words or phrases that when selected, generate a spoken sentence. For example, selecting beverages will show a screen with listed beverages, such as soda, water, iced tea, milk, etc. If the user were to click on soda, the device will respond through its speaker—“I would like a soda.”

Choice lists are also provided which allow multiple selections. For example, the user can select breakfast and a breakfast menu will appear. The menu includes numerous varieties of typical breakfast fare such as eggs, bacon, sausage, etc. and the user can select any number of the items, which will then be combined in a single sentences—e.g., “I would like orange juice, fried eggs, sausage links, home fries, toast and coffee for breakfast.” To further assist the disabled individual, the display will also preferably include alternative forms of communication, such as images of the selected items and the text of the sentence being spoken.

The user devices are also preferably configured to allow communications between two speech disabled users that are physically located near and in line of sight of each other. This feature makes use of the interactive list category. Each SGMTD is configured with a proprietary list of personal and general questions that are specific to the user. The answers to these questions are entered into the individual's device during initial programming by the vendor of the device or the caregiver. The SGMTDs are configured such that selection of one of the questions by Survivor A of a first SGMTD will cause transmission of a code to nearby Survivor B's SGMTD that will automatically access the corresponding answer to the question from memory in Survivor B's SGMTD. At the same time, the stored audio clip is played by Survivor A's SGMTD. Assuming Survivor B wants to communicate with Survivor A, Survivor B need only actuate the select button on their touch screen, which will cause the answer to the question both to be played using the corresponding audio clip and transmitted via the IR link to Survivor A's SGMTD for display on his or her screen. As an example, if question 01 on the list is “what is your name,” the second SGMTD will respond by transmitting the response—John Smith. Infra-red or a similar wireless technology is preferably used to implement the interactive feature so the user can control which SGMTD they want to communicate with if there are more than two SGMTDs on at the same time. In the case of IR communications, the user points their SGMTD directly at the other survivor's SGMTD.

All personal information that the user desires and their responses will be programmed into the SGMTD. Preferably, this is accomplished through access to an Internet web site which provides hundreds of detailed lists that may be downloaded or used while connected to the Internet. The menu will be limited primarily to single words and the options under the menus will also be primarily one word, yet the responses will be full coherent sentences. More particularly, simple lists can be turned into complete sentences with addition of a few words, thus allowing the survivor a very functional way to communicate.

The caregiver COMTD is also a hand held device but operates in a completely different manner than does the SGMTD. In particular, the COMTD is paired with the survivor's SGMTD and sends commands via wireless communications only (no audio) to the SGMTD. The purpose of the COMTD is to alleviate the survivor of trying to figure out what screen to go to when asked a question by the caregiver. The caregiver can select a question which they think the survivor may want to ask. When they enter the selection on their caregiver COMTD, the device sends a command to the SGMTD that causes the survivor's menu to switch to the list. The survivor than enters one or more particular items on the list if desired, from which the caregiver wishes the survivor to select an answer. An example would be if the caregiver were to select the lunch category, the survivor's SGMTD will switch to the lunch menu. More specifically, if the caregiver has a good idea what the survivor wants for lunch, they can cause the survivor's SGMTD to switch to the list of lunch items and have already highlighted particular items, such as cheeseburger, fries and a COKE. All that the survivor need do if they approve of the particular selection of items, is to press the select button which will generate the audible sentence: “I want a cheeseburger, fries and a COKE for lunch.” Even though the survivor may readily comprehend the caregiver's spoken question, switching of the menu on the survivor's SGMTD display screen in this manner makes the selection process much easier for the survivor.

### BRIEF DESCRIPTION OF THE DRAWINGS

The features and advantages of the present invention will become apparent from the following detailed description of a preferred embodiment thereof, taken in conjunction with the accompanying drawings, which are briefly described as follows.

FIG. 1 is an illustration of a communication system configured in accordance with the preferred embodiment of the present invention showing the basic components of the system.

FIGS. 2A and 2B are top plan and right side perspective illustrations of one design of the physical structure of a hand held terminal device that can be configured either for a speech impaired individual or a caregiver or other non-disabled individual.

FIG. 3 is a block diagram showing the internal components of a speech generating mobile terminal device (SGMTD) that is configured for use by a speech impaired individual for communicating with other disabled and non-disabled individuals.

FIG. 4 is a block diagram showing the internal components of a companion mobile terminal device (COMTD) that is designed to be used by a non-disabled individual, such as a caregiver, to communicate with the SGMTD in a manner that assists the survivor in communicating with the non-disabled individual.

FIG. 5 is an illustration of a screen shot of the SGMTD's display.

FIG. 6 is an Illustration of a screen shot of the COMTD's display.

FIG. 7 is a flow chart showing the communication protocol between a survivor SGMTD and a caregiver COMTD.

### DETAILED DESCRIPTION OF THE INVENTION

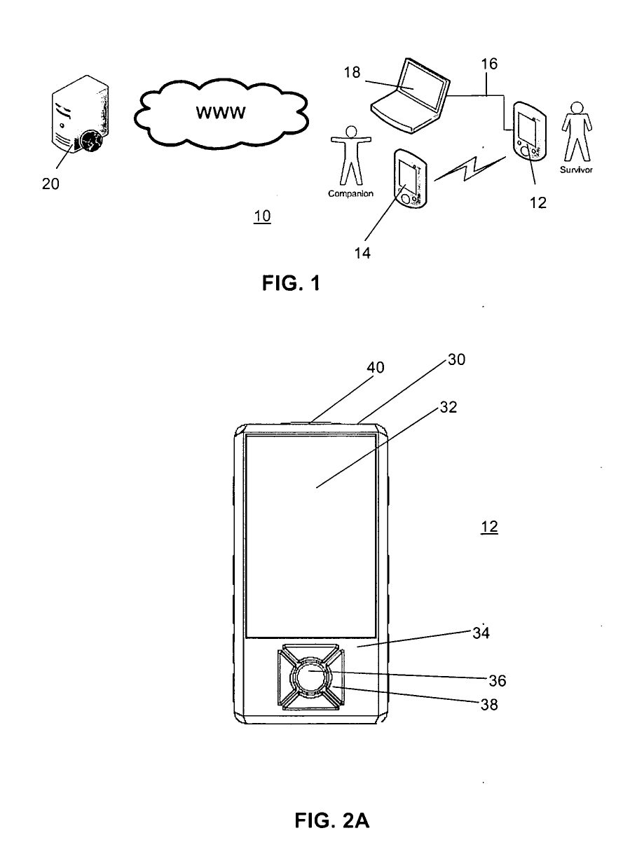

FIG. 1 illustrates a communication system 10 that is configured in accordance with a preferred embodiment of the present invention. The system 10 enables individuals with severe communication disabilities to engage in meaningful communication with those around them, including other disabled users of the system 10 and non-disabled users, such as caregivers. The system 10 also enables speech therapy providers to create speech exercise programs for the users with severe communication disabilities.

The communication system 10 includes a programmable speech generating mobile terminal device (SGMTD) 12 for use by a stroke survivor or other speech impaired individual and a companion mobile terminal device (COMTD) 14, for use by a caregiver, for example, and is paired with and programmed to communicate only with the particular SGMTD 12. The SGMTD 12 and the COMTD 14 preferably communicate via a USB connection 16 with a customization and configuration application, which is resident on any suitable computer, such as a laptop computer 18. The computer 18 can itself be loaded with all menu data necessary to program the SGMTD 12 and the COMTD 14. However, an Internet accessible remote computer or server 20 at a dedicated Internet website is preferably used for this purpose. The customization and configuration application is preferably employed to program the SGMTD 12 and COMTD 14 as will be discussed in greater detail herein.

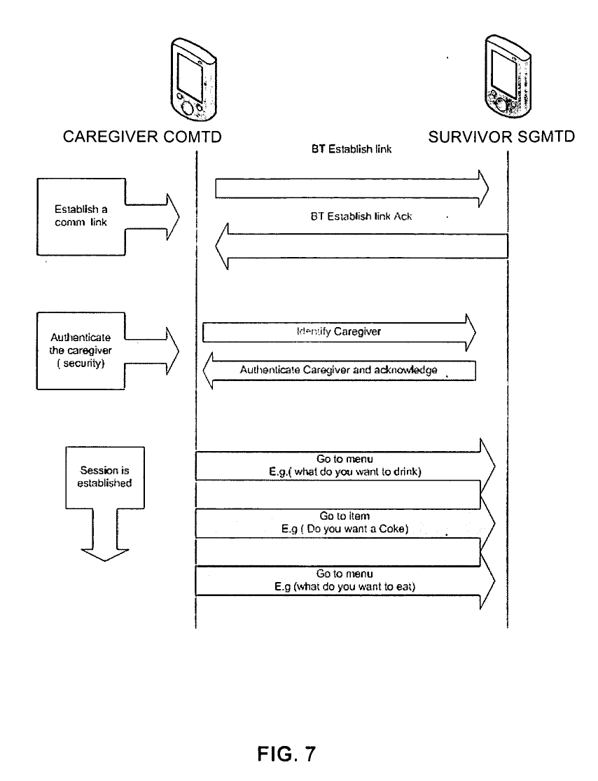

The SGMTD 12 is an intuitive, handheld device that is used by the user with speech and other communication disabilities (referred to hereinafter as the survivor). The COMTD 14 is a limited scope communications device that enables discreet guided communication with the SGMTD 12. The COMTD 14 is as intuitive and easy to use as the SGMTD 12. As will be discussed in greater detail herein with reference to FIG. 7, the COMTD 14 includes a wireless communication scheme that allows the COMTD 14 user to direct the SGMTD 12.

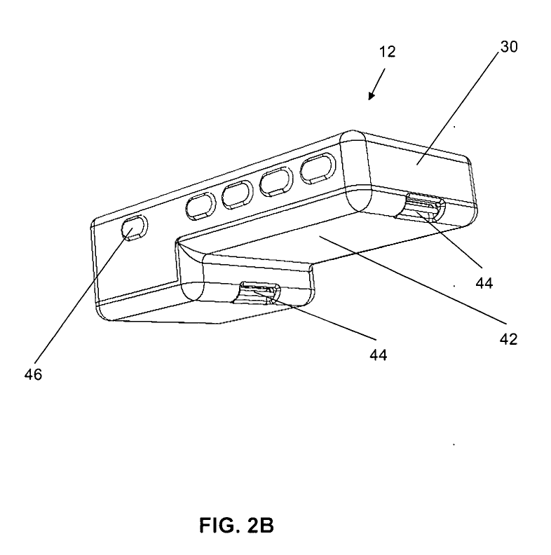

The SGMTD user interface is specifically designed to allow users with low manual dexterity to effectively operate the device. FIGS. 2A and 2B illustrate one possible implementation of the SGMTD 12, which is also preferably used for the COMTD 14 for convenience. Although it will be understood that the design of the SGMTD 12 is not limited to any particular design, the device must be easy to hold in one hand and preferably operated by a thumb or finger of the survivor, who is apt to have limitations on motor skills on one side of their body, in addition to their speech disability. In the design shown in FIGS. 2A and 2B, the SGMTD 12 includes a housing 30 that has overall dimensions on the order of 3.5″×5.5″×1.5″ and a weight of approximately 0.5 lbs.

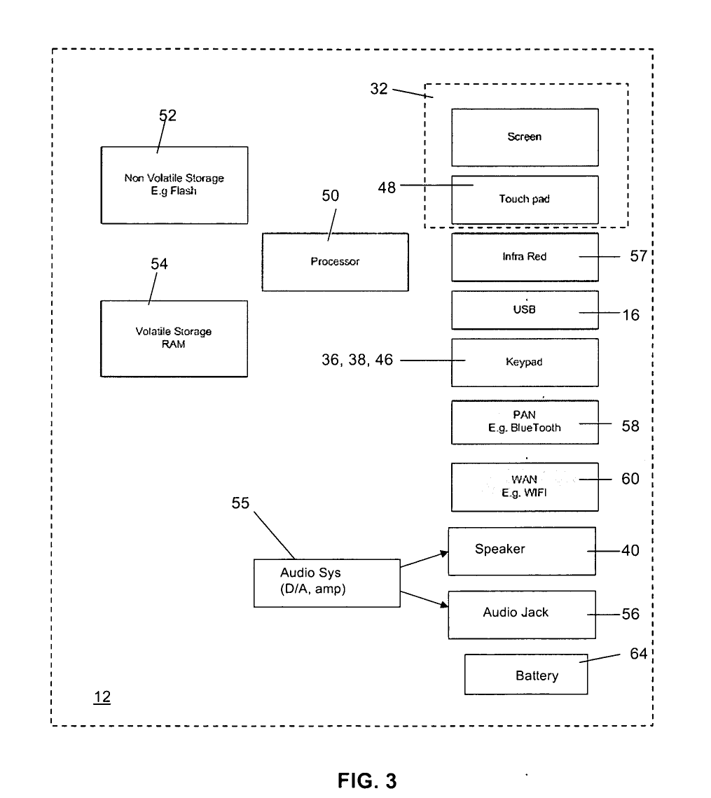

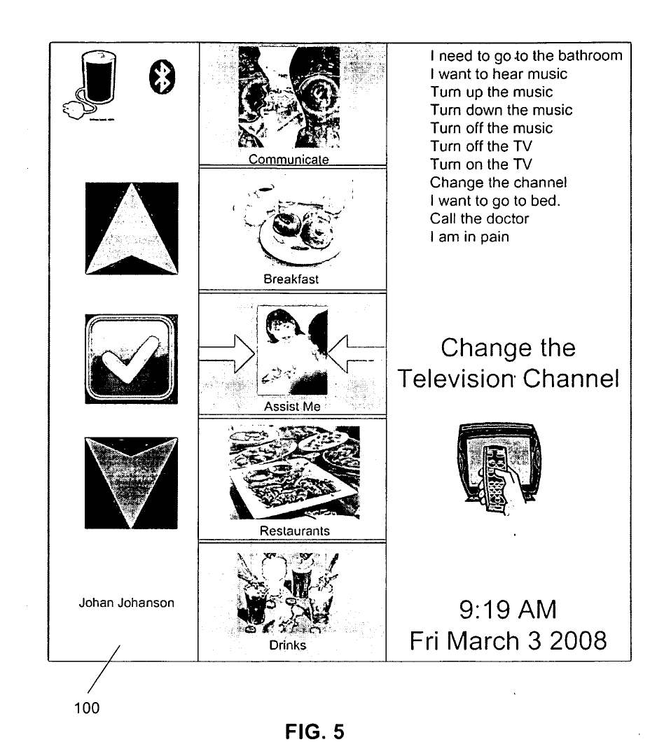

As shown in FIG. 2A, the SGMTD 12 includes a graphical display 32 that takes up much of the top side 34 of the housing 30. To enable the survivor to enter selections into the SGMTD 12, a center button 36 and a group of four arrow buttons 38 are shown also positioned on the top side 34 of the housing 30 below the display 32. These buttons are optional, however, and are preferably replaced by making the graphical display 32 an LCD touch screen type with buttons that are software generated as discussed later in conjunction with FIGS. 3 and 5. In this case, the LCD touch screen 32 can be made as large as the top side 34 of the housing 30. An audio speaker 40 is also preferably disposed on the top end of the housing 30 to play audible sentences in response to selections made by the survivor.

As illustrated in FIG. 2B, the housing 30 includes a contoured underside 42 that allows easy grasping of the device by the survivor's hand. First and second strap slots 44 are provided for reception of first and second ends of a strap (not shown) which assists the survivor in holding SGMTD 12 in the palm of their hand. A second optional group of five buttons 46 is disposed along the side of the housing 30 for entering selections into the SGMTD 12. Again, it will be understood that the button configuration on the SGMTD 12 can be varied as desired and customized to each survivor's particular condition in regards dexterity and motor skills.

FIG. 3 is a block diagram showing the hardware components which are preferably contained in the SGMTD 12. The SGMTD 12 is a mobile computational platform that has the ability to communicate with other SGMTDs and the dedicated COMTD 14 which is operated by a caregiver or other non-disabled individual who is communicating with the survivor. The SGMTD 12 also has the ability to communicate with the personal computer 18 via the USB interface 16 for programming the SGMTD 12.

The SGMTD 12 interacts with the survivor through audio, graphical and textual prompts to convey information to the survivor. The survivor interacts with the SGMTD 12 using the available buttons 36, 38 and/or 46 and/or a touch pad 48 that is formed integral with the screen display 32.

The SGMTD system components include a processor 50 for executing the SGMTD application and an audio codec for playing streaming audio files; a large (e.g. 60 Gigabyte) non volatile storage memory 52 for storing the application program, menu configuration, media content (e.g. audio files, image files, etc.) and the user identify information; and a RAM 54 for storing the application program and transient data during execution of the SGMTD application. The SGMTD 12 is preferably configured to play audio files that are in the WAV or similar format. In this regard, the SGMTD 12 preferably also includes an audio sub-system 55, which receives decoded WAV or other files from the codec application and includes a D/A converter and an amplifier. The output of the audio system 55 is fed to the speaker 40 and to an audio jack 56 that allows the survivor to use headphones.

The LCD touch screen display 32 displays the menus and images contained in the SGMTD application and provides the survivor with the input interface via the touch pad 48. The screen 32 preferably has areas upon it that are designated as buttons. These include an ‘UP’, ‘DOWN’ and ‘OK’ button, for example. The display 32 is preferably readable in an in-direct sunlight (day light) environment.

A wireless IR transceiver interface 57 is provided which uses irDA to communicate and is employed to allow two SGMTDs, which are in close proximity (e.g. 10 feet) to one another; to communicate as will be discussed in greater detail later. The inter SGMTD communication IR is used to provide an ad-hoc communication mechanism that requires a line of site between SGMTDs, which matches interpersonal communication.

The SGMTD 12 preferably uses a different wireless communication technology to communicate with the COMTD 14. The SGMTD 12 is paired with the COMTD 14 before delivery of the devices to the end user so that the COMTD 14 can only communicate with its paired SGMTD. The wireless communication technology is referred to as a PAN (personal area network) 58 and may be based on any one or more of Wifi, WiMax, CDMA (EVDO), GSM (EDGE/HSDPA) or BLUETOOTH. The specific wireless technology used may be country or application specific and will adhere to local regulations or deployment constraints. The wireless technology used will provide a secure and tamper proof communication path between the caregiver's COMTD 14 and the survivor's SGMTD 12. The PAN 58 is used to gain larger range and to relieve the users from establishing a line of sight between the units. A WAN (wide area network) 60 can also be used if desired to provide access directly from the SGMTD 12 to the Internet.

The SGMTD 12 is preferably powered by a rechargeable battery 64 having at least an 8-hour battery life with ‘normal’ usage. The SGMTD platform utilizes power management techniques to maximize the battery life. The rechargeable battery 64 can be a NiMH (Nickel Metal Hydride) type, but is preferably a Lilon (Lithium Ion) type due to its lightweight and charging capacity. The SGMTD housing 30 preferably has a jack (not shown) for connecting the battery to a charger.

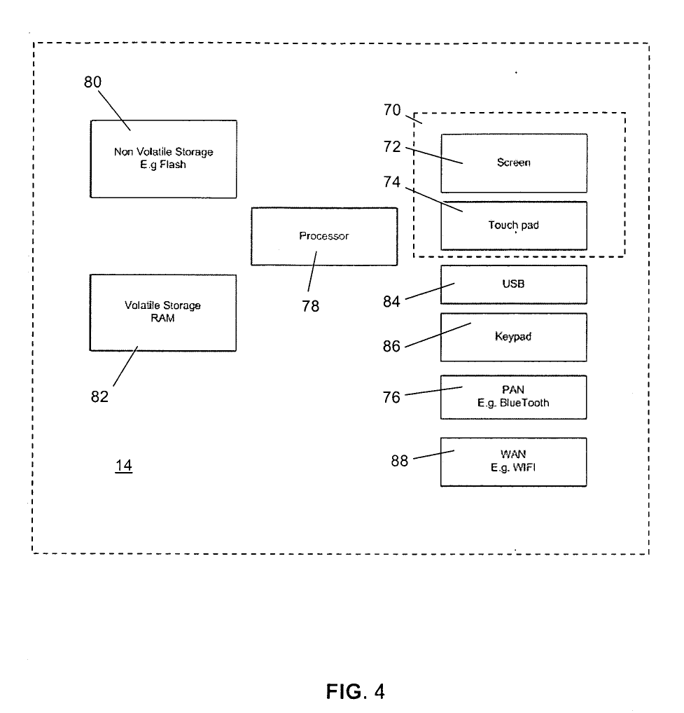

FIG. 4 is a block diagram of the components employed to implement the COMTD 14, which uses a different platform from that of the survivor's SGMTD 12. The COMTD 14 is intended to provide a wireless communication link between the caregiver and the survivor devices. The caregiver using the COMTD 14 does not share the dexterity or the communications limitations of the survivor using the SGMTD 12. As a result, the configuration of the COMTD 14 is substantially different from that of the SGMTD 12 and does not employ audio playback capabilities or IR communication capabilities. However, the COMTD 14 like the SGMTD 12, is also preferably a portable, hand held device, which uses the same housing 30 of the SGMTD 12 shown in FIGS. 2A and 2B, and includes an LCD display 70 having a screen 72 formed integrally with a touch pad input 74. The COMTD 14 also uses a PAN 76 to communicate with the one SGMTD 12 bound to it. In addition, the COMTD 14 also includes a processor 78, non-volatile storage memory 80, a RAM 82 and a USB interface 84 for programming the COMTD 14. As in the SGMTD 12, an optional keypad 86 and WAN 88 can be provided if desired.

FIG. 5 is a screen shot of an exemplary main screen 100 that can be displayed on the touch screen 32 of the SGMTD 12. As illustrated, the main screen 100 indicates the following information to the user: battery level: communication connectivity status; date and time; owner; currently selected category. Also, images of selected items and text of sentences to be spoken are shown.

The SGMTD button behavior is preferably tunable to allow different dexterity deficiencies to be accommodated by the application. The tuning includes the semantics of the button (Up, Down, Right, Left, OK etc.). The tuning also includes the maximum and minimum repeat rate, de-bouncing timers and filters. The button dynamic parameters are aggregated into profiles that match users that share a particular disability. The grouping of the SGMTD button behavior into a disability profile is preferably done in conjunction with professionals in the health care field.

The SGMTD menu system provides a simplified navigation method, since the survivor is apt to have manual dexterity limitations as already noted. Thus, the menu is preferably kept to a maximum depth of 2 layers. The menu system within the SGMTD 12 is 100% externally configurable. That is the SGMTD 12 has no assumptions on the structure or content of the menu tree. The entire structure is preferably defined, verified and downloaded to the SGMTD 12 through the web based configuration application.

Each menu item with the SGMTD 12 has the following attributes which define the user experience of the SGMTD 12. First, each menu item must have a textual representation of its contents. The textual representation is preferably limited to strings in the ISO 8859-1 character set. Each menu item also preferably has a graphical text element. The graphical text element adds the ability to animate text along with an optional audio clip that speaks the text. The animation will typically entail the highlighting of the word being spoken in the audio portion. Since normal speech is quite fast, the user has the ability to touch the slow button and the device slowly high lights each word and pronounces it. The graphical animation preferably uses a standard method (i.e. animate GIF) to create the animation effect. The synchronization of the audio to the graphical text will be done at the time of text creation. Specifically the SGMTD application does not perform any speech to text functions to achieve the animation.

Optionally, each menu item may also have an image associated with it. Not only does a list appear, but the highlighted selection will reveal a picture. As the survivor scrolls down, a new picture will appear. These are not icons, but real photographs of foods in high quality JPEGs, for example. The image is preferably a thumbnail image of any suitable format, e.g. JPEG, GIF, etc., that represents the menu item selection, such as an image of a cheese burger or other food item to be selected for a particular meal. The previously mentioned audio clip is also optional and may be assigned to a menu item when it is first selected. Furthermore, the audio clip may be placed on auto loop and auto loop with a timeout. The audio clips are preferably stored in WAV file format and can be downloaded through the web application interface to the SGMTD 12. In this regard, different voices (e.g. older, younger, regional, etc.) or languages may be selected for the WAV files when they are downloaded from the website.

Each menu item may also have an action associated with it. The action associated with a menu item defines what the SGMTD 12 will do when the survivor selects that menu item by pressing the button designated as ‘OK’. The actions are preferably selected as a set of actions to perform. For example: Play audio clip for 5 seconds, go to communication menu. The action settings preferably include the following.

Go to menu—This enables the multiple tier menu scheme.

Play Audio—Plays an audio clip for either a certain amount of time or a button press or either event.

Display Image—Displays an image when the user selects the menu item. The image is cleared upon another button press.

Display Text—Displays text on the screen. The text is cleared upon any button press.

Terminal Settings—Enable the survivor to control the behavior of the SGMTD 12. The SGMTD 12 requires no initial configuration by the survivor. However, some of the behavior of the SGMTD 12 can be controlled by the survivor using the terminal settings. In particular, the survivor can: enable and disable the sound; increase or decrease the volume; and enable and disable communication with another SGMTD. The settings are all accessible through a menu within the user interface. The enabling of the control menu and the selection of the items available within it are preferably entirely settable from the web configuration tool.

Each SGMTD 12 preferably has a list of informational attributes unique to the survivor. The list of available attributes includes a set of basic identifying elements along with a companion configurable set of customizable attributes. The basic set preferably includes such elements as the survivor's name, residence, college attended, children's names, phone #, spouse name, primary physician, favorite team, etc. The SGMTD 12 has a menu item called “info display” that will allow the survivor to select these items. The actions associated with each item in the info menu may be assigned as in any other menu.

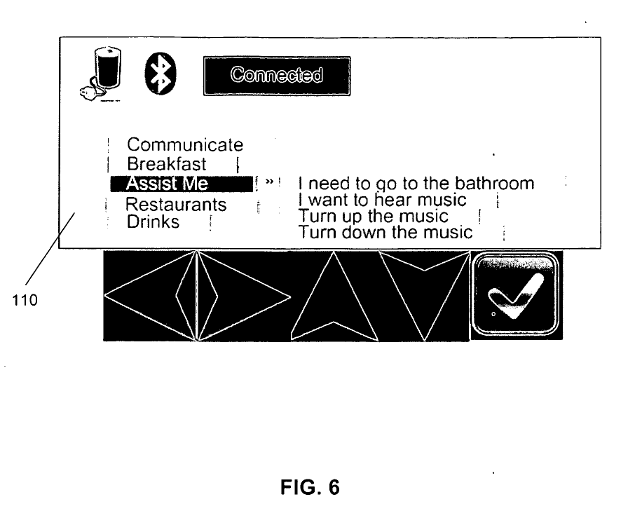

With reference now to FIG. 6. a screen shot 110 of the caregiver COMTD 14 menu configuration is shown. The COMTD 14 contains the identical menu structure as the SGMTD 12. The COMTD 14 allows the caregiver to scroll to any location within the menu hierarchy and with the push of the ‘synch’ button, will cause the SGMTD 12 to automatically go that location. This allows the caregiver's COMTD 14 to facilitate the navigation of the SGMTD 12 by having the caregiver zero in on a menu or item therein, while allowing the survivor to make the final choice. The COMTD 14 can scroll within the menu leaving the survivor the need only to press OK when the appropriate item is highlighted. This allows a private non-verbal communication between the COMTD 14 and the SGMTD 12 and allows the COMTD to supply a ‘short cut’ to guide the SGMTD to the appropriate menu.

FIG. 7 illustrates the communications protocol between the COMTD 14 and the SGMTD 12. Before the SGMTD 12 and COMTD 14 can begin communicating, a communication link must be established between the two. Once the communication link is established, a subsequent step authenticates the COMTD against the SGMTD 12. This second step is necessary to prevent a situation were an arbitrary COMTD and SGMTD communicate. Because the two devices must have their menu structure synchronized, the two devices will authenticate each other before communicating.

As already discussed, the caregiver COMTD 14 is designed to alleviate the survivor from trying to figure out what screen to go to when asked a question by the caregiver. The caregiver can select a question which they can ask and then when they push the selection on their caregiver COMTD, it will correspondingly change the survivors screen to where he can select the answer. An example would be if the caregiver were to select “what would you like for lunch?” This will cause the display on the survivor's SGMTD 12 to switch to the lunch menu. This could also be a list of medical questions developed by pathologists that would enact a screen on the survivor's SGMTD 12 of responses that would help the pathologist or therapist in the survivor's recovery process. All caregiver questions enact a specific survivor screen. The SGMTD 12 and the COMTD 14 are pre-configured with a usable menu. The use of the Web configuration is not be required to begin using the system.

Wireless technology for ad hoc communication requires a point-to-point scheme in a personal area network environment. The mechanism should require no user intervention or configuration. IrDA (infrared) is the preferred wireless communications technique for communications between two SGMTDs that are within say 10 feet of each other. Line of sight issues are an acceptable compromise for ease of use. Wireless technology for Companion to Survivor may use a PAN e.g. Bluetooth since devices may be bound at the factory and communication does not require ad hoc connectivity.

During operation of the SGMTD 12, a number of usage scenarios will occur. For example, the SGMTD 12 has a menu item titled “Order Pizza.” When selected, the SGMTD 12 will play an audio clip stating that the survivor would like to order a pizza. The survivor scrolls to that menu item and presses OK. The audio clip for ordering pizza plays. While the clip plays, the survivor may press a button to halt the audio clip. When the clip finishes playing, the survivor may press OK to repeat the clip. The same thing occurs when the survivor scrolls to the info display and selects an item. The action associated with the item for example an audio clip stating “My name is Johan Johansen” is played.

The SGMTD 12 can also communicate without audio clips, but instead via textual communication on the SGMTD display 32. For example, the SGMTD 12 has a menu item entitled “Bathroom assistance” which, when selected, causes the words “Please assist me in the bathroom” to display prominently on the display. There is no audio clip associated with this menu item and therefore none will play. Any button press by the survivor will dismiss the display

There is also preferably a communications protocol for communications between two survivor SGMTDs. When two SGMTD devices are near each other, they may in an ad hoc manner initiate a “conversation”. The conversation between two SGMTDs involves the exchange of the info element attributes which are preprogrammed into each SGMTD. The SGMTD 12 will display the info elements from only one other unit at a time. This is to maintain simplicity and in keeping with a 1:1 communication paradigm.

First, Survivor A brings their SGMTD within the line-of-sight IR transmission range of Survivor B (approx. 10 feet or less). Survivor A can then initiate a “conversation” with Survivor B by pointing their device in the general direction of Survivor B's SGMTD and selecting one of any number of preprogrammed questions that are resident in each SGMTD. For example, if Survivor A selects “what is your name” from the preprogrammed list of questions, their SGMTD will speak the question “what is your name” and at the same time transmit a code to Survivor B's SGMTD. When the code is received, Survivor B's SGMTD will retrieve the answer to the question from memory along with the corresponding audio clip. All Survivor B has to do is to press their select or enter touch pad button and Survivor B's name will both be spoken by Survivor B's SGMTD and transmitted to Survivor A's SGMTD for simultaneous display. In this manner, both survivors can have a meaningful in depth conversation with one another, with the only limitation being the number of questions and corresponding answers, which can number in the hundreds or more. Once the conversation is concluded, the peer SGMTD information will be maintained within a SGMTD until the survivor exits the info menu.

The web based configuration tool allows a user to update and re-configure the SGMTD and COMTD menu structure. Since the SGMTD and COMTD share the menu structure, both devices must be synchronized. The companion or health practitioner logs onto the dedicated website. After providing their credentials, they are directed to an application, which allows the creation of a menu. Once the user completes the menu creation, the web application prompts the user to connect the SGMTD 12 and COMTD 14 in turn to the USB port of the personal computer 18. The new menu item is saved from the website to the SGMTD 12 and COMTD 14.

Through the utilization of manageable lists on the accounts section of the website, the caregiver or survivor are able to create, edit, view and delete various speech lists. These lists are then able to be downloaded in a unique file format that is readable by that user's specific handheld device. The preliminary list synchronization occurs after the initial list setup is completed. The caregiver selects an option to download the lists to the survivor's SGMTD. The list is packaged into a pre-defined message format that will be instantly received, unpackaged and executed by the SGMTD 12. The SGMTD 12 is connected through either a PC cable (USB) or through a wireless connection. After the caregiver or survivor selects the option to download, the message file is assigned a unique header ID that corresponds to the particular SGMTD 12. This is done by assigning headers to the message file to facilitate uni-directional and bi-directional communication. The file is then transmitted from the website to the SGMTD 12 and is installed on the SGMTD 12 via an auto-running executable. The SGMTD 12 then transmits an acknowledgement message to the user interface to verify that the file was correctly and completely transmitted and installed. If an error occurred during the process, the SGMTD 12 will transmit a pre-defined error message along with any pertinent information back to the user interface.

After the initial synchronization, the caregiver can then connect the COMTD 14 to the computer and conduct an automated synchronization. The COMTD 14 will be enabled to securely connect to the account list via the computer connection and then, through a synchronization initiation, will automatically download and update the list files on the COMTD 14 following the same process as listed above.

The COMTD 14 and SGMTD 12 must have the same menu structure. If the user configures a new menu structure in the SGMTD 12 and fails to do so in the COMTD 14, there may arise the situation where the menus are unsynchronized. Each menu item shared between the COMTD 14 and the SGMTD 12 is thus preferably assigned a globally unique non-repeating key. Thus any mismatch between the two will be easily detectable by the SGMTD 12 and it will ignore the communication unless a key match occurs.

The menu structure is preferably defined in an XML document. The XML document is enclosed in a MIME multipart that contains the audio and image clips associated with the menu. The entire menu scheme and its associated media objects are contained in the MIME document. Finally, the website is responsible for creating the MIME doc and this is downloaded to the COMTD and SGMTD. The configuration application on the laptop computer 18 is a Microsoft .NET control that receives the MIME document from the browser and downloads it through USB to the COMTD 14. The installation of the code will be automatic from the web site to the user's computer. The website will include all necessary mechanisms to download and install the code and explain to the users what will happen.

Finally, the communication between the hand held devices preferably uses anti tamper and data link integrity checks as provided by the underlying communication technology. Internet communication security will utilize SSL and is provided by the web server and browser. All text within the SGMTD 12 and COMTD 14 is in the ISO 8859-1 character set and as such covers the Latin based languages.

Although the invention has disclosed in terms of a preferred embodiment and variations thereon, it will be understood that numerous additional variations and modifications could be made thereto without departing from the scope of the invention as defined in the following claims.

1. A communication system for facilitating communication between a speech impaired individual and other individuals comprising:
a first, speech generating mobile terminal communication device (SGMTD) that is of a size that it can be hand held and operated by a speech disabled individual, said device including:
a display for displaying at least one menu of items that the individual can select;
a storage memory for storing a group of digital audio files, each of which corresponds to an item on said at least one menu;
an audio system including an amplifier and an audio speaker for playing a selected one of said audio files; and
a processor interfaced to said audio system for executing a streaming audio application that, in response to selection of an item from said menu, accesses an audio file from said memory which corresponds to said item and plays an audible sentence through said audio system which requests an action associated with the selected menu item; and
a wireless transceiver for transmitting and receiving communications from other devices; and
a second, companion mobile terminal device (COMTD) which is programmed to communicate only with said first, SGMTD and includes:
means for entering a command for instructing said SGMTD to switch to a particular menu from which said disabled user is to select at least one item; and
a wireless transmitter for transmitting said command to said SGMTD and thereby causing said SGMTD to switch to the menu designated by said command.

2. The system of claim 1, wherein said processor also executes an application that displays a sentence to be spoken on said display.

3. The system of claim 2, wherein said processor highlights each word in said sentence on said display as it is audibly spoken.

4. The system of claim 2, wherein said processor also displays an image of a selected item on said display.

5. The system of claim 1, wherein said SGMTD also includes a second, IR transceiver for communicating with other SGMTDs that are in range of said IR transceiver.

6. The system of claim 5, wherein said SGMTD includes a database of questions and corresponding answers which are stored in said memory and said processor is further programmed to access, in response to a question received by said IR transceiver from another SGMTD, a corresponding answer from said memory and enable said disabled individual to select said answer with a single input and thereby cause said answer both to be spoken by said audio system and transmitted as text to the SGMTD from which the question was received.

7. The system of claim 1, wherein said display is a touch screen display that includes a plurality of touch screen buttons for enabling said disabled individual to enter menu selections into said SGMTD.

8. The system if claim 1, wherein the menus in said first SGMTD and said second device are both configurable via USB interfaces from a web based application.

9. The system of claim 1, wherein said menu further comprises a two tier tree structure including a first tier of categories that can be selected by said disabled individual and a second tier of lists of items that are included in each of said categories.

10. The system of claim 9, wherein said menu includes lists from which multiple items can be selected and cause generation of a single spoken sentence that combines and references each of said items that the disabled individual has selected.

11. The system of claim 1, wherein said COMTD includes a display and said means for entering commands comprises a duplicate menu from which items can be selected by a non-disabled individual operating the COMTD.

12. A system for facilitating communication between first and second speech disabled individuals comprising:
first and second speech generating mobile terminal communication devices (SGMTD), each of which is of a size that it can be hand held and operated by one of said speech disabled individuals, each said device including:
a display for displaying lists of questions which said first speech disabled individual can ask of said second speech disabled individual; and lists of answers to questions which can be asked of said first speech disabled individual by said second speech disabled individual;
a storage memory for storing a database of questions and corresponding answers in response to a question received by said IR transceiver from another SGMTD, a corresponding answer from said memory and enable said disabled individual to select said answer with a single input and thereby cause said answer both to be spoken by said audio system and transmitted as text to the SGMTD from which the question was received. first and second groups of digital audio files, each of which corresponds to a question on said list of questions item on said at least one menu;
an audio system including an amplifier and an audio speaker for playing a selected audio file; and
a processor interfaced to said audio system for executing a streaming audio application that, in response to selection of an item from said menu, accesses an audio file from said memory which corresponds to said item and plays an audible sentence through said audio system which requests an action associated with the selected menu item; and
a line of sight IR transceiver for transmitting and receiving communications between said first and second SGMTDs.

13. The system of claim 12, wherein said processor in each said SGMTD also executes an application that displays a sentence to be spoken on said display.

14. The system of claim 13, wherein said processor highlights each word in said sentence on said display as it is audibly spoken.

15. The system of claim 13, wherein said processor also displays an image of a selected item on said display.

16. The system of claim 12, wherein said display on each said SGMTD is a touch screen display that includes a plurality of touch screen buttons for enabling said disabled individual to enter menu and other selections into said SGMTD.

17. The system if claim 12, wherein the menus in said SGMTDs are both configurable via USB interfaces from a web based application.

18. The system of claim 12, wherein said menu further comprises a two tier tree including a first tier of categories that can be selected by said disabled individual and a second tier of lists of items that are included in each of said categories.

19. The system of claim 18, wherein said menu includes lists from which multiple items can be selected and cause generation of a single spoken sentence that combines and references each of said items that the disabled individual has selected.

20. The system of claim 12, wherein each said SGMTD includes an RF wireless transceiver for communicating with a dedicated companion device that can command said SGMTD to select a particular menu or menu item for selection by a disabled individual.
